(19) United States
(12) Patent Application Publication
(10) Pub. No.: US 2003/0135737 A1
(43) Pub. Date: Jul. 17, 2003

(54) Method for protecting an exchange of data by remote means

(76) Inventor: Nicolas Bouthors, Chemin de Beausejour (FR)

Correspondence Address: David D. Stein, Boyle, Fredrickson, Newholm, Stein & Gratz, S.C., Suite 1030, 250 E. Wisconsin Avenue, Milwaukee, WI, 53202, US

(21) Appl. No.: 10/335,281

(22) Filed: Dec. 31, 2002

(30) Foreign Application Priority Data
Dec. 31, 2001 (FR) 01 17096

(51) Int. Cl. H04L 9/00

(52) U.S. Cl. 713/176

(57) ABSTRACT

Upon receipt (201) of a message, an operator determines (211) the rules that this message must satisfy in order to be forwarded to its addressee. These rules depend on the sender (202) and the addressee (204) of the message. Depending on degree to which the message satisfies these rules, the operator marks the message and forwards it to its addressee. Thus an operator's subscriber or a provider need only verify that the marking to accept the message.

The present invention relates to a method for protecting an exchange of data by remote means. The field of the invention is networks in which it is possible to access data of various kinds via a terminal, such access being contingent on a subscription agreement with a service provider. Networks of such kind may be, for example, the Internet for private individuals, or mobile telephony networks. In order to gain access to data and to these networks, the user of a terminal that allows connection to these networks must take out a subscription. One aim of the invention is to reinforce the confidence of users in networks of such kind. A further aim of the invention is to minimise the impact of security procedures on the end user.

Systems are known in the state of the art that enable content or data, described as active, to be received by a device such as a personal computer. Content is considered to be active when its interpretation engages functions other than the function of display on the device by which it is interpreted. Besides its display function, the functions of a device may include for instance communication, storage, and processing.

According to the state of the art and in the field of personal computers there are at least two major types of active content: active content that is accepted by default, which includes scripts, Java type “applets”, and active content which cannot be downloaded or initialised without the active authorisation of the device user. The latter types of active content are known as “plug-ins” or extensions to the browser software. When such an extension is downloaded, the user receives a request to accept the extension. To make his choice easier, the extension is accompanied by a certificate that enables him to identify the organisation or service provider which is transmitting the extension. An extension of such kind enables improved control of browser software, for example, on the device that is used to run the software.

The two types of active content indicated in the aforegoing are received by a user's device following a request made by the user. In other words, a user has transmitted a request, using the HTTP protocol for example, to receive a Web page, which is a file in HTML format. This file in HTML format then includes the active content which is interpreted by the browser software.

A first problem in this arrangement is that the user is not naturally disposed to handling the certificates that accompany the extensions. Thus, the browser software displays a prompt requesting the user to confirm that he accepts the extension, which has been transmitted by such and such an organisation. As often as not, the user does not understand the “jargon” that accompanies this question and does not attempt to verify the validity of the certificate. It is then possible for ill-intentioned persons to pass themselves off as a reputable organisation, or simply disguise their nefarious purposes. This being the case, the user who is aware of such may prefer to refuse the extensions almost without exception rather than expose himself to the smallest risk. In doing so, in his attempt to exercise caution, the user limits the services to which he might have access if a system existed that would allow him to place greater confidence in the methods used to disseminate such extensions.

This problem also exists in the domain of mobile telephony. It should be noted that it is indeed possible to access the Internet, i.e. active content as described above, from a mobile telephone. However, the problem in the case of mobile telephony is further aggravated by the existence of “push” mode. This means that the user of a mobile telephone end device may receive active content without having authorised the receipt. This mode of functioning owes its existence to the fact that mobile end devices need to conserve energy. It is expensive for a mobile end device to have to interrogate servers regularly within the context of a messaging application, for example. It is much simpler for the messaging server to send a message to the mobile end device as and when a message is addressed thereto.

Moreover, the control functions that are exercised in a unit of the mobile end device type by scripts or “applets” that are compatible with that mobile end device are significantly more extensive than is the case for personal computers. It is therefore advisable to exercise extreme caution when handling such active content in a mobile end device, the prudent user declines them as a matter of course.

A further problem associated with mobile end devices consists in that their storage capacity is low, and their computing capacity is limited. This means that they are unable not only to store certificates in a database, but also to process such a certificate database in real time. Consequently, a solution modelled on the one that is used in the field of personal computers cannot be implemented for mobile telephony. Moreover, if such a solution were to be implemented, it would not be ergonomically acceptable because it would require the user to make an active response, as in the field of personal computers. Such is therefore not ideal.

A further problem arises on the side of the provider. Indeed, it may be that the provider wishes to obtain guarantees regarding the validity of a request or of a response to a request transmitted by a subscriber. According to the state of the art, the subscriber does this using signatures and certificates in the same way as the provider does to guarantee its data. Thus, the subscriber must install sophisticated certification technologies on his end device, and the provider must put in place the means to verify the guarantees submitted by the subscriber. Since a provider may receive a large number of requests, the enormous increase in verification operations, as well as the complexity thereof, represents a problem in terms of response time, which may frustrate the user and discourage him from calling the provider again.

The invention resolves these problems by minimising the effort that is associated with verification for both subscriber and provider. Accordingly, the operator who receives a message is responsible for verifying that it is in compliance with the rules affecting the operator, the sender of the message and the addressee of the message. If these rules are observed, the operator forwards the message, if they are not observed, the operator interrupts transmission of the message and, under certain circumstances, may inform the transmitting party that his message does not satisfy the conditions for forwarding. Thus, the operator verifies signatures, and certificates as well as the format and content of the message. When such verifications have been successfully completed, the operator marks the message before forwarding it. When the addressee receives the message, he needs only to verify the mark applied by the operator in order to be sure that the message he has just received is in compliance with the conditions that he, the addressee, has prescribed for the operator. In this way, from the point of view of both subscriber and provider, message verification is reduced to a simple check of a mark that is appended by an operator.

The object of the invention is therefore a method for remotely assuring the security of an exchange of data between a subscriber to a telecommunications network operator and a provider using a telecommunications network managed by the operator, characterised in that the operator implements the following steps:

receipt of a message,

identification of the sender of the message,

identification of the recipient of the message,

determination of the rules to be applied to the message,

application of the rules to the message to determine whether the message needs to be forwarded,

marking of the message,

forwarding to the addressee of the message, marked and compliant with the rules.

The invention will be better understood with reference to the following description and to the attached drawings. The drawings are for representational purposes only and are not to be considered limiting of the invention in any way. In the drawing:

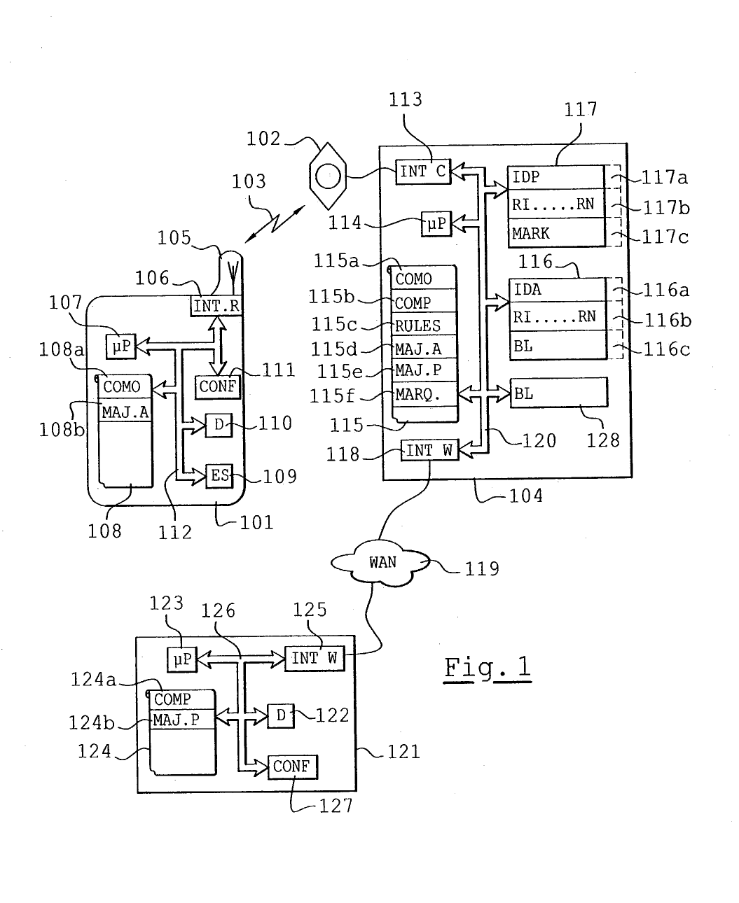

FIG. 1: is an illustration of means useful for realising the method according to the invention;

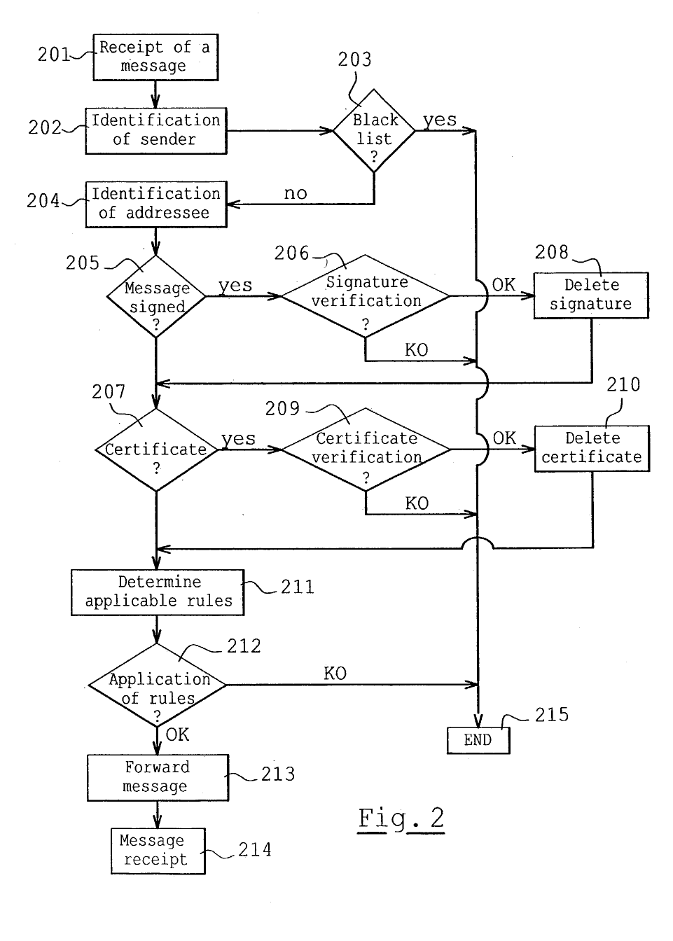

FIG. 2: is an illustration of process steps according to the invention;

The following description relates to the operator, the subscriber, and the provider. All are present on one or more networks. The subscriber uses a mobile telephone end device to communicate with the equipment managed by the operator. The provider has a server that enables it to communicate with the operator's equipment. In the description, actions are attributed to the terminal, the subscriber, the operator, and the provider. Of course, these actions are performed by the equipment corresponding to these different entities. Accordingly, an action performed by the subscriber is realised via his terminal and the microprocessor included in that terminal. The microprocessor is controlled by instruction codes recorded in a terminal memory. The same applies to the servers managed by the operators and the providers. Every server includes a microprocessor and a program memory including instruction codes for controlling these microprocessors.

FIG. 1 shows a terminal 101 that is connected to a telecommunications network 102 via a microwave link 103. For the purpose of the description, and in a preferred embodiment, network 102 is considered to be a mobile telephone cellular network, and terminal 101 is therefore a mobile telephone. Network 102 is managed by a mobile telephony operator via servers connected to this network 102. FIG. 1 shows such a server 104.

Terminal 101 includes a communications interface that allows it to establish a connection 103 with network 102. This communications interface consists of a radio antenna 105 and radio interface circuits 106 assuring transcoding between the analog signals on the side of antenna 105 and the digital signals in terminal 101. Conventionally, terminal 101 includes a microprocessor 107, a program memory 108, and input/output means 109. Input/output means 109 include a keyboard and a screen.

Terminal 101 further includes a data memory 110. It is in this memory that the active data received by terminal 101 is recorded. A memory 111 of terminal 101 allows the configuration of that terminal to be recorded, and particularly enables the prescribed response of server 104 to be recorded, depending on the type of messages received by server 104, these messaged being intended for receipt by terminal 101.

Memory 108 includes several zones. In particular, memory 108 includes a zone 108a that carries instruction codes for controlling microprocessor 107 when terminal 101 communicates with server 104, that is to say when telephone 101 communicates with the operator. Terminal 101 includes a zone 108b corresponding to an update of the subscriber's configuration on server 104.

For terminal 101, as for the other devices that will be described in the following, a certain number of memories are described. For a given device, this group of memories, may well consist of just a few zones of the same memory. The exploded illustration of the elements is provided as an aid to understanding.

Elements 106 to 111 are connected by a bus 112. Network 102, and thus also terminal 101, function according to any existing or future mobile telephony standards. These standards include for example GSM, PCS, DCS, GPRS and UMTS.

The operator's server 104 includes circuits 113, which enable it to establish an interface between network 102 and server 104. Server 104 includes a microprocessor 114 and a program memory 115. Memory 115 is divided into a number of zones containing instruction codes that control microprocessor 114 depending on circumstances. One zone 115a enables server 104 to communicate with terminal 101, one zone 115b enables server 104 to communicate with a provider wishing to use the operator's network 102. One zone 115c enables server 104 to determine and apply the rules applicable to the messages received by server 104. One zone 115d enables server 104 to update a table 116 of the operator's subscribers. One zone 115e enables server 104 to update a table 116 of providers using the operator's network. One zone 115f enables server 104 to mark messages for forwarding.

Server 104 also includes a provider table 117. Terminal 104 also includes interface circuits 118 between server 104 and a telecommunications network 119, for example the Internet. Elements 113 to 118 and 128 are connected to a bus 120.

Tables 116 and 117 are table-structured memories. Each line corresponds to an item of information, each column corresponds to a record, that is to say a subscriber for table 116 and a provider for table 117. Table 116 permits the recording of information on an operator's subscribers, and table 117 permits recording of information on providers wishing to use the network of the operator managing server 104.

Table 117 includes a line 117a corresponding to a provider identifier. A line 117b corresponds to a list of rules agreed upon by the operator managing server 104 and the provider identified in line 117a. A line 117c corresponds to a list of marks agreed upon by the operator managing server 104 and the provider identified in line 117a; each mark may have a meaning, for example message compliant or message non-compliant.

Table 116 includes a line 116a for recording a subscriber identifier. In the case of a mobile telephone network, the line identifier in 116a is, for example, a telephone number or a SIM card number. Table 116 also includes a line 116b corresponding to a list of rules defining the characteristics of messages that the subscriber identified in line 116a may, or wishes to receive. A line 116c corresponds to a black list. Each subscriber has the option of identifying providers or message senders from whom he no longer wishes to receive any messages at all. This list is recorded in line 116c, in the column corresponding to the subscriber's identifier. This black list may include, for example, identifiers of a type such as those on line 117a.

Server 104 also contains an operator's black list memory 128. This black list 128 belongs to the operator. Black list 128 includes, for example, a list of the providers, or rather a list of identifiers of providers who are not authorised to use the operator's network.

FIG. 1 also shows a server 121 corresponding to a device of a provider wishing to use network 102 of the operator managing server 104. For the purposes of the description, the example is given of a provider or server 121 wishing to transfer data recorded in a memory 122 to terminal 101. Server 121 includes a microprocessor 123, a program memory 124, and interface circuits 125 for communicating with network 119. Server 121 may also include a configuration memory 127 for editing rules corresponding to the provider that uses server 121. Elements 122 to 126 are connected by a bus 127. Memory 124 includes a zone 124a enabling the implementation of communication functions with the operator's server 104. Memory 124 includes a zone 124b enabling the implementation functions for updating table 117 on the basis of the contents of configuration memory 126 of server 121.

All the elements described for FIG. 1 are engaged by the process according to the invention. The steps of this process are illustrated in FIG. 2.

FIG. 2 shows a step 201 of a message being received by the operator.

In a first example, the sender is assumed to be a provider wishing to send a message to a subscriber to the operator's network. This message has thus been transmitted by server 121, using the communication protocol resident in zone 124a of memory 124. Server 104 receives this message because of the protocol resident in zone 115b of memory 115. The protocols in zones 115b and 124a are identical, this may be a standard Internet communication protocol for instance.

The method then proceeds to a step 202, that of identifying the sender. Currently, all messages exchanged over any network include a field for the inclusion of a sender identifier. When the sender is a provider, it may be assumed that this field is an Internet type address. Identifying the sender is simply a matter of reading the sender's Internet address in the message received in step 201. Once this information has been obtained, the method proceeds to step 203, verification of the black list.

In step 203, server 104 scans memory 128 to find the identifier that was determined in step 202. If this identifier is present in black list 128, the method passes directly to a termination step 215, the message will not be forwarded, that is to say not beyond the operator. IN this case, server 104 interrupts transmission of the message received in step 201.

If the identifier determined in step 202 is not present in black list 128, the method proceeds to step 204, that of identifying the addressee. For the purposes of this example, the operator managing server 104 is a mobile telephone network operator. In this case, the addressee's identifier is, for example, a telephone number. If the operator were an Internet access provider, the identifier might be an Internet type address also, identifying the addressee is thus a matter of reading the addressee field in the message received in step 201. Once the identifier of the addressee has been determined it is possible to confirm whether the message received in step 201 does satisfy all the conditions necessary to allow it to be forwarded to the terminal identified by the identifier determined in step 203.

The method then passes from step 204 to a step 205, that of determining the presence of a signature. If the message received in step 201 includes a signature, the method passes to a step 206 of signature verification, otherwise it advances to a step 207, that of determining the presence of a certificate in the message.

If the message includes a signature, this may be an electronic signature, for instance, compliant with the French and European regulations. A signature of such kind is produced and verified in known manner. The most familiar mechanism for signature verification is described in PKI (Public Key Infrastructure) technologies. However, any other signature technology upon which both the provider and the operator have agreed may be implemented in step 206. If the signature is valid, the method proceeds to a step 208, that of deleting the signature, if the signature is not valid, the method proceeds to step 215.

Step 208 is optional. In this step, the operator modifies the received message so that the signature appended by the provider is removed. Since this signature has already been verified by the operator, nothing is gained by forwarding it. This step may serve to economise on bandwidth. However, for legal reasons, it may be desirable to transmit the signature. After step 208, the method then proceeds to step 207. Where step 208 is optional, the method proceeds from step 206 to 207 when the signature is correct.

In step 207, if the message received in step 201 includes a certificate, the method proceeds to step 209, that of verification of the certificate. In step 209, the operator reads the certificate contained in the message of 201 and connects to a certification authority server that issues the certificate, which may be a certification server accessible via the Internet, for example. This certification server informs the operator as to whether the certificate has been rejected or not. If the certificate has not been rejected, which is to say it is valid, the method proceeds to step 210, that of removing the certificate, otherwise the method passes directly to step 215.

Like step 208, step 210 is optional. Deleting the received message's certificate in step 210 allows a bandwidth saving when the message is forwarded, which means less information is transmitted and transmission time is optimised, as well as the message backup space. From step 210, the method passes to a step 211. If step 210 is not implemented, and provided the certificate is valid, the method proceeds from step 209 to 211. If the certificate is not valid, the method passes from step 209 directly too step 215 in all cases.

The operator is able to determine whether a message includes a signature and/or a certificate because such has been agreed previously in the communication protocol it uses with the provider. A communication protocol defines a structure for messages that are exchanged in accordance with that protocol. This structure itself defines fields for the signature and the certificates. The fact that these fields are reported or not therefore indicates the presence or absence of a signature and/or a certificate.

In step 211, the operator scans provider memory 117, and specifically line 117a, to find the identifier determined in step 202. With this, it can find a first list of rules 117b to apply to the message received in step 201.

These rules are particular to each provider wishing to use the operator's network 102. For example, the rules apply to the nature of the message, the size of the message the number of messages the provider may send in a given period, etc. The size of the message is easy to determine, its nature may be encoded in a field of the message received in step 201. Most often, messages are used to transmit files. Therefore, it is easy to determine the nature of a file. For example, the most familiar files are executable files, HTML files, text files, etc.

The set of rules in line 117b has been negotiated between the operator and the provider identified in column 117a. If the message received in step 201 satisfies all the applicable rules applying to the provider identified in line 117b, the operator proceeds to the rules applying to the intended recipient of the message.

To do this, the operator searches line 116a for the identifier determined in step 204. When this is found, it reads line 116c corresponding to this identifier. Line 116c is the operator's own black list. This list functions according to the same principle as memory 128 in step 203. In order for a message to be validated, the identifier determined in step 202 must not be present in the black list of the subscriber to whom the message is addressed.

The rules in line 116b are identical to those defined for a provider unless are the subscriber's own rules. A subscriber may wish not to receive messages larger than a certain size, or messages that include an executable file, from any source at his terminal. The message received in step 201 must therefore pass through the filtering system defined by the subscriber. The rules in line 116b that apply to the message received in step 201 are determined in the same way as for line 116c, that is to say via the identifier determined in step 204, which enable a column to be identified in table 116.

Step 212 is the step in which these rules are applied. If the message received in step 201 is caught in the rules filter, the method proceeds directly to step 215. Otherwise, the method continues to step 213, that of forwarding the message.

In step 213, the operator implements a protocol that is resident in zones 115a and 108a to transmit the message received in step 201 to the addressee, that is to say a subscriber to its network. Most often, the protocols used for communication between the operator and the provider and between the operator and the subscriber are not the same. The operator is therefore responsible for converting protocols. Accordingly, in step 213 the content of the message received in step 201 is retrieved without applying steps 208 and 210, and placed in a frame that is compatible with the protocol the operator uses for communicating with the addressee. This may mean sending the content via short messages (SS) or the WAP (Wireless Application Protocol), for instance. In step 213, before the message is forwarded, the operator changes it by adding a mark. This mark is added in a specific field of the forwarded message. The method then proceeds to a step 214, that of receipt of the message by the addressee.

In step 214, the addressee subscriber receives a message. The first thing the subscriber's terminal 101 does on receiving the message is search for the operator's mark. If this mark is present, the terminal knows that it may trust the content of the message implicitly and execute all the actions associated with the nature and content of the message it has just received. For example, the message may contain an active content the interpretation of which causes an appointments database in terminal 101 to be updated. Since the message is marked, this update is performed without any intervention on the part of the user of terminal 101. If the message received by the subscriber does not include this mark, the subscriber must decide whether to accept or refuse the message. This means that the subscriber, the user of terminal 101, decides how to deal with each message on a case by case basis.

In a variant of the invention, failure at steps 206, 209 and 212 does not cause the transmission of the message received in step 201 to be aborted; instead the message is not marked, or a mark is applied indicating that the message does not satisfy the conditions for forwarding. In this case, the final addressee receives the forwarded message either unmarked or bearing a mark identifying a message that has not satisfied the requirements of the rules. The addressee's terminal or server cannot trust the message in this case, and sets in motion its own verification system, which may include requesting the intervention of the subscriber or the provider before the content of the message is implemented or saved.

The instruction codes in zone 108b allow the subscriber to update the column in memory 116 that pertains to him. To do this, he uses elements 109 to edit the content of configuration memory 111. When he has finished editing this configuration, it is forwarded to the operator so that the content of the column in memory 116 pertaining to the subscriber may be replaced. In a variant thereof, the subscriber's configuration is backed up on server 104. In this case, in order to be able to edit it, the subscriber must first transfer the content of his configuration from server 104 to memory 111, then make the desired editing changes and update memory 116.

The rules and marks used between the operator and the provider tare updated in the same way as for the subscriber, unless the configuration memory is memory 127 of server 121. In the case of a provider, this update may also be effected by mail: the provider sends a letter to the operator indicating the modifications it wishes to make to its rules, and the operator is responsible for updating its server.

If the message sender is a subscriber, such as may be in the case of an online purchase, the provider then receives an order message bearing a mark attached by the operator. This mark indicates either that the verifications carried out by the operator have been successful, or that they have not. If they have been successful, the provider knows that it can honour the order with confidence because the operator acts as guarantor therefor. Otherwise, the provide may either decline the order or institute its own verification mechanisms before deciding whether to accept the order. The process is thus symmetrical, whether message is sent by the provider to the subscriber or by the subscriber to the provider. However, the operator might be less inclined to delete the signature on a message sent by a subscriber to a provider, because a provider may wish to keep the signatures for legal reasons against the possibility that a dispute with the subscriber regarding the object of his message.

In a further variant, it may be desirable to vary the rules for a provider depending on whether it is the sender or the recipient of a message. Accordingly in this variant, the rules in line 117b each include a supplementary field corresponding to their application with reference to the status of the provider. In this way, in step 211 it is possible to make a distinction among all the rules pertaining to the provider as to which are to apply to the provider as sender, and which are to apply to the provider as addressee. This provision may equally be applied to the rules for subscribers, after all they too may be either sender or recipient.

The procedure described may be implemented on any type of network that involves an operator, subscribers and providers. Such networks include mobile cellular telephone networks, and also the Internet for private individuals. Indeed, anyone who wishes to connect to the Internet must do so with the aid of an Internet Service Provider (ISP). The service provider's servers may then implement the procedure. This enables the terminals used by the subscribers to be configured more simply, and also means that the terminal users no longer have to wonder about the ins and outs of the messages that may pop up on their terminals when the operator is not responsible for the security of the messages they receive.

For the sake of clarity, we have decided to represent the rules in two separate tables 116 and 117. IN practice, all the rules could be included in one table, and step 211 would extract from this one table all the rules applicable to a message received by the operator. However, a rule must have at least the following features: sender's identifier, addressee's identifier, and a condition relating to a property of the message. A message property may be its size, its nature with reference to its content, or a binary field in which each bit would have a meaning. Upon receipt of a message, therefore, its properties may be determined by measuring or reading a property field of the message. In this case, it is simple to determine the appropriate rules and apply them.

The marks used by the operator to mark forwarded messages are known only to those directly involved in the process. A mark is preferably a binary word that has meaning for the addressee. This meaning has been decided in consultation with the operator. The test of the value of a mark therefore provides information about the validity of a message. The marks used may be variable over time in a predetermined manner or at the instigation of one of the agents on the process.

1. A method for remotely assuring security when exchanging data between a subscriber to a telecommunications operator and a provider using a telecommunications network managed by the operator, characterised in that the operator implements the following steps:
receipt (201) of a message,
identification (202) of the sender of the message,
identification (204) of the recipient of the message,
determination (211) of the rules to be applied to the message,
application (212) of the rules to the message to determine whether the message needs to be forwarded,
marking (213) of the message,
forwarding (213) to the addressee of the message, marked and compliant with the rules.

2. The method according to claim 1, characterised in that the recipient of the message verifies (214) the presence and the validity of the marking in order to accept the message.

3. The method according to one of claims 1 or 2, characterised in that the message is signed by its sender, the operator verifies (206) the validity of the signature as an additional condition for its forwarding.

4. The method according to one of claims 1 to 3, characterised in that the message is accompanied by a certificate, the operator verifies (209) the validity of the certificate as an additional condition for its forwarding.

5. The method according to any of claims 1 to 4, characterised in that the application of the rules includes (203) verification that it is not included in a black list of sender identifiers defined by the addressee.

6. The method according to claim 5, characterised in that the black list is retained by the operator.

7. The method according to any of claims 1 to 6, characterised in that the application of the rules includes verification of the size of the message.

8. The method according to any of claims 1 to 7, characterised in that the application of the rules includes verification of the nature of the message.

9. The method according to any of claims 1 to 8, characterised in that the application of the rules includes a check of the frequency of messages for an addressee or a sender.

10. The method according to any of claims 1 to 9, characterised in that for a message signed by the sender the operator deletes (208) the signature of the sender of the message.

11. The method according to any of claims 1 to 10, characterised in that for a message including a certificate the operator deletes (210) the message's certificate.
